(19) United States
(12) Patent Application Publication
(10) Pub. No.: US 2026/0204815 A1
(43) Pub. Date: Jul. 16, 2026

(54) Battery Clamp Assembly

(71) Applicant: Schumacher Electric Corporation, Fort Worth, TX (US)

(72) Inventor: Barry O’Dell, Fort Worth, TX (US)

(21) Appl. No.: 19/017,002

(22) Filed: Jan. 10, 2025

(51) Int. Cl. H01R 11/24; H01R 4/18

(52) U.S. Cl. CPC H01R 11/24; H01R 4/185

(57) ABSTRACT

Described is a battery clamp assembly. The battery clamp assembly includes a first clamp portion, a second clamp portion pivotally coupled with the first clamp portion via a pivot pin, a first insulator, and a second insulator. The first clamp portion includes a first handle portion and a first jaw portion, while the second clamp portion includes a second handle portion and a second jaw portion. The first insulator is coupled to an exterior surface of the first clamp portion, while the second insulator is coupled to an exterior surface of the second clamp portion. A crimp electrical connector is coupled to the first handle portion to electrically couple with a conductor while a threaded electrical connector is coupled to the second handle portion to electrically couple with a conductor.

### BACKGROUND

Electrical clamps are essential components in various applications, particularly in automotive systems such as battery chargers and jump starters. These clamps serve as interfaces for establishing secure electrical connections, enabling the safe and efficient transfer of power.

Traditional electrical clamp designs typically feature a single type of connector tailored for a specific conductor size or cable type. Commonly, these designs incorporate either crimp electrical connectors or threaded electrical connectors for attaching cables. The choice of connector is influenced by the conductor's characteristics, such as its size and current rating, which are often determined by the wire gauge. In general, smaller gauge wires (i.e., larger-diameter), which can carry higher currents, require connectors designed to handle such loads and wire diameter. Conversely, larger gauge wires (i.e., smaller-diameter), suited for lower current applications, necessitate different connector configurations. Crimp electrical connectors, known for their ability to handle high-current applications, are widely used in demanding electrical environments. In contrast, threaded electrical connectors offer ease of installation and removal but are sometimes better suited for lower-current scenarios. These design constraints often limit the adaptability of traditional clamps to specific conductor types.

Existing electrical clamps, however, are often gauge-specific or, at best, capable of accommodating only a narrow range of conductor sizes. As a result, users must maintain an inventory of various clamps to match different conductor sizes and current requirements. This not only increases the complexity of managing on-hand parts but also elevates costs associated with maintaining a diverse inventory of clamps with varying part numbers. Such limitations pose challenges in achieving flexibility and efficiency in electrical systems.

In view of the foregoing, the subject disclosure provides a battery clamp assembly to address the limitations of conventional clamps by offering compatibility with a wide range of conductor sizes and current requirements.

### SUMMARY

The present disclosure relates generally to a battery clamp assembly, substantially as illustrated by and described in connection with at least one of the figures, as set forth more completely in the claims. More specifically, the present disclosure relates to clamp and clamp assemblies, specifically a battery clamp assembly for electrical connections, and more particularly to a battery clamp assembly that provides, inter alia, both crimp and threaded connections for versatile and efficient attachment of battery cables.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a front perspective assembled view of a battery clamp assembly in accordance with aspects of the present disclosure.

FIG. 1b illustrates a front perspective assembly view of the battery clamp assembly.

FIG. 1c illustrates a rear perspective assembled view of the battery clamp assembly.

FIG. 1d illustrates a side elevation assembly view of the battery clamp assembly.

FIG. 1e illustrates a side cross sectional view of the battery clamp assembly taken along cutline A-A (FIG. 1c).

FIGS. 1f and 1g illustrate side elevation views of the battery clamp assembly in, respectively, a closed position and an open position.

FIG. 1h and 1i illustrate, respectively, underside and top side isometric views of clamp insulators of the battery clamp assembly.

FIG. 2a illustrates a front perspective assembled view of the battery clamp assembly.

FIGS. 2b and 2c illustrate, respectively, front and rear views of the battery clamp assembly.

FIGS. 2d and 2e illustrate, respectively, first and second side views of the battery clamp assembly.

FIGS. 2f and 2g illustrate, respectively, top and bottom plan views of the battery clamp assembly.

FIG. 3a illustrates a front perspective assembled view of the clamp.

FIGS. 3b and 3c illustrate, respectively, front and rear views of the clamp.

FIGS. 3d and 3e illustrate, respectively, first and second side views of the clamp.

FIGS. 3f and 3g illustrate, respectively, top and bottom plan views of the clamp.

FIGS. 3h and 3i illustrate, respectively, topside and underside isometric assembly views of the clamp.

FIGS. 4a and 4b illustrate, respectively, first and second side views of a clamp in accordance with another aspect.

FIGS. 4c and 4d illustrate, respectively, first and second rear perspective views of the clamp of FIGS. 4a and 4b.

FIGS. 5a and 5b illustrate, respectively, first and second side views of a clamp in accordance with yet another aspect.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Battery chargers and battery boosters may be used to charge an external battery and/or start (a/k/a “boost”, “jump”, or “jump-start”) an engine operatively coupled to the external battery. Battery chargers and battery boosters can be removable connected to the external battery via a pair of battery clamp assemblies.

Electrical clamps are vital components in applications like automotive battery chargers and jump starters, enabling secure and efficient power transfer. Traditional clamp designs typically feature connectors tailored to specific conductor sizes or types, often using crimp electrical connectors for high-current applications or threaded electrical connectors for lower currents. These designs are influenced by conductor characteristics, such as wire gauge, with smaller gauges (larger diameters) suited for high currents and larger gauges (smaller diameters) used for lower currents. Existing clamps are gauge-specific or can accommodate only a narrow range of conductor sizes, necessitating a diverse inventory of clamps to meet varying requirements, increasing complexity and costs.

The subject disclosure therefore provides a battery clamp assembly to address the limitations of conventional clamps by offering compatibility with a wide range of conductor sizes and current requirements. The proposed solution simplifies component design and assembly, reducing the need for multiple specialized clamps while maintaining reliable performance across diverse applications.

In one example, a battery clamp assembly comprises: a first clamp portion having a first handle portion and a first jaw portion, wherein a crimp electrical connector is coupled to the first handle portion that is configured to electrically couple with a conductor; a first insulator coupled to an exterior surface of the first clamp portion; a second clamp portion having a second handle portion and a second jaw portion, wherein a threaded electrical connector is coupled to the second handle portion that is configured to electrically couple with a conductor, and wherein the second clamp portion is pivotally coupled with the first clamp portion via a pivot pin; and a second insulator coupled to an exterior surface of the second clamp portion.

In one example, a battery clamp assembly comprises: a first clamp portion having a first handle portion and a first jaw portion, wherein a first crimp electrical connector is integrally formed with the first handle portion and configured to electrically couple with a conductor; a first insulator coupled to an exterior surface of the first clamp portion; a second clamp portion having a second handle portion and a second jaw portion, wherein a second crimp electrical connector is integrally formed with the second handle portion and configured to electrically couple with a conductor, and wherein the second clamp portion is pivotally coupled with the first clamp portion via a pivot pin; and a second insulator coupled to an exterior surface of the second clamp portion.

In one example, a battery clamp assembly comprises: a first clamp portion having a first handle portion and a first jaw portion, wherein a first electrical connector is coupled to the first handle portion; and a second clamp portion having a second handle portion and a second jaw portion, wherein a second electrical connector is coupled to the second handle portion, and wherein the second clamp portion is pivotally coupled with the first clamp portion via a pivot pin.

In some examples, the first electrical connector is a crimp electrical connector.

In some examples, the second electrical connector is a crimp electrical connector.

In some examples, the second electrical connector is a threaded electrical connector.

In some examples, the first clamp portion is formed as a stamped metal component where the first handle portion and the first jaw portion are a unitary structure.

In some examples, the second clamp portion is formed as a stamped metal component where the second handle portion and the second jaw portion are a unitary structure.

In some examples, the second electrical connector is coupled to the second clamp portion via at least one of welding, brazing, soldering, and mechanical fastening.

In some examples, the first clamp portion is formed as a stamped metal component where the first handle portion, the first jaw portion, and the first electrical connector are a unitary structure.

In some examples, the second clamp portion is formed as a stamped metal component where the second handle portion, the second jaw portion, and the second electrical connector are a unitary structure.

In some examples, the threaded electrical connector comprises a metal plate with a threaded hole configured to accommodate a threaded fastener.

In some examples, the metal plate is oriented parallel to the handle portion.

In some examples, the metal plate is positioned at a distal end of the handle portion.

In some examples, the metal plate is coupled to the handle portion via at least one of welding, brazing, soldering, and mechanical fastening.

In some examples, each of the first clamp portion and the second clamp portion comprises one or more slots.

In some examples, the battery clamp assembly further comprises a first insulator coupled to the first clamp portion via one or more slots formed in the first clamp portion and a second insulator coupled to the second clamp portion via one or more slots formed in the second clamp portion.

In some examples, the first electrical connector is a crimp electrical connector configured to couple with a first conductor and the second electrical connector is a crimp electrical connector configured to couple with a second conductor that is larger in diameter than the first conductor.

In some examples, the first electrical connector is a first crimp electrical connector, and the second electrical connector is a second crimp electrical connector that is larger than the first crimp electrical connector.

In some examples, the first electrical connector and the second electrical connector have different current ratings.

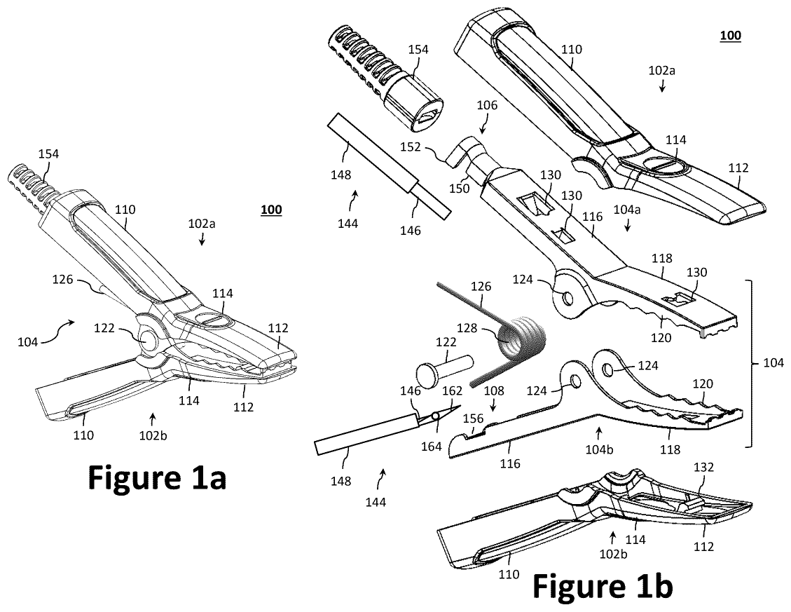

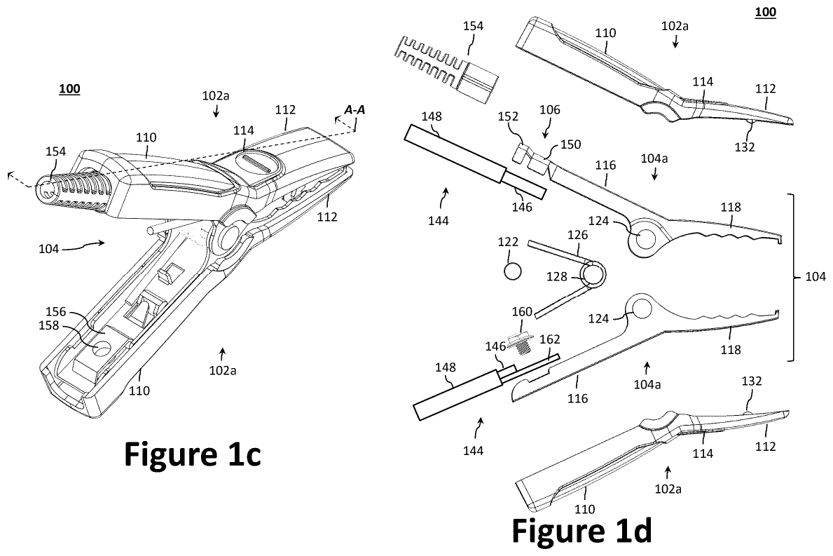

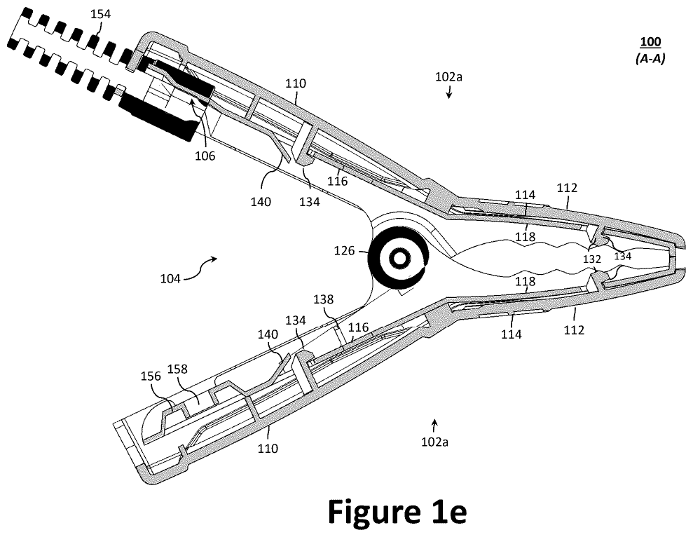

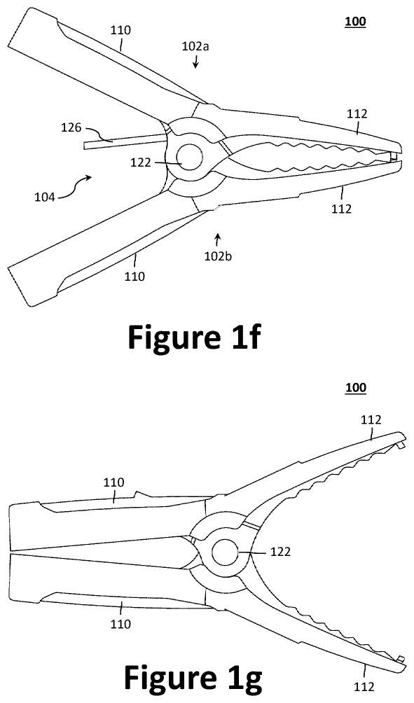

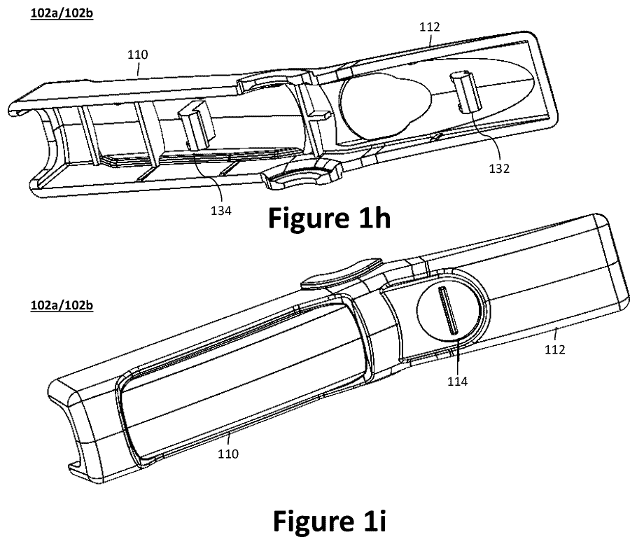

FIG. 1a illustrates a front perspective assembled view of a battery clamp assembly 100 in accordance with aspects of the present disclosure. FIG. 1b illustrates a front perspective assembly view of the battery clamp assembly 100, while FIG. 1c illustrates a rear perspective assembled view of the battery clamp assembly 100. FIG. 1d illustrates a side elevation assembly view of the battery clamp assembly 100, while FIG. 1e illustrates a side cross-sectional view of the battery clamp assembly 100 taken along cutline A-A (FIG. 1c). FIGS. 1f and 1g illustrate side elevation views of the battery clamp assembly 100 in, respectively, a closed position and an open position. FIG. 1h and 1i illustrate, respectively, underside and top side isometric views of clamp insulators 102a, 102b of a clamp housing 102 of the battery clamp assembly 100.

A battery clamp assembly 100 according to the present disclosure comprises a clamp housing 102 connected to a clamp 104. The clamp housing 102 is constructed from an electrically insulating material, such as resin, synthetic resin, plastic, rubber, fiberglass, composite, or other suitable materials, while the clamp 104 is made of an electrically conductive material, such as metal, steel, metal alloy, plated steel, or anodized aluminum.

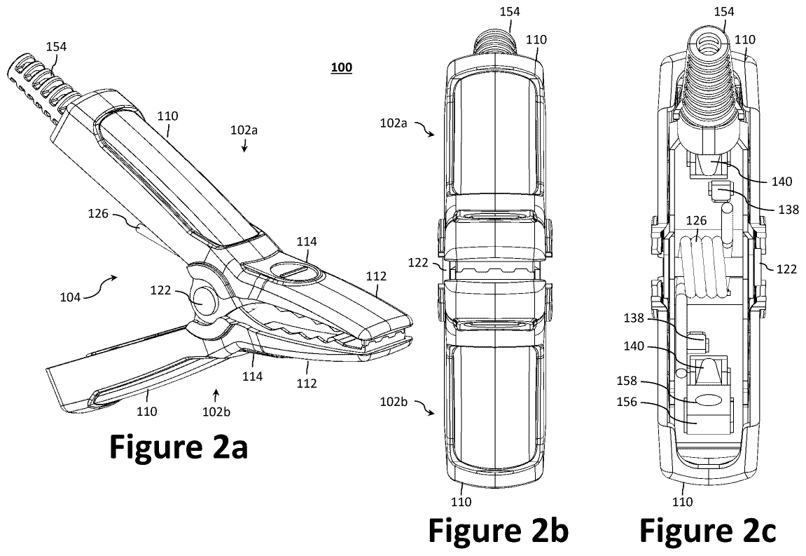

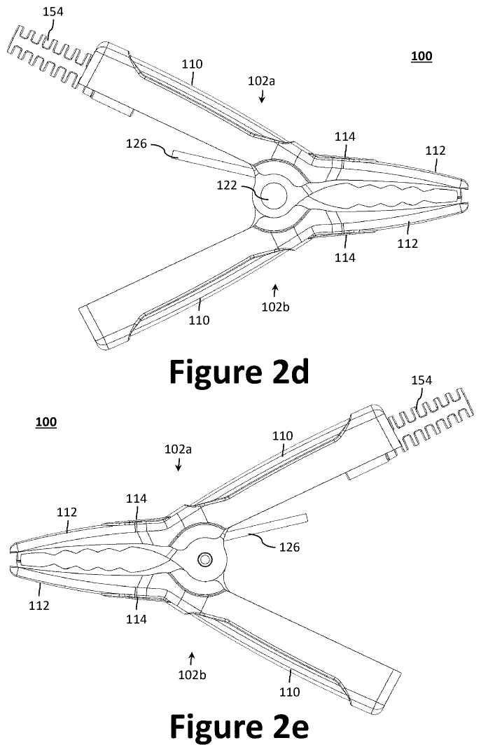

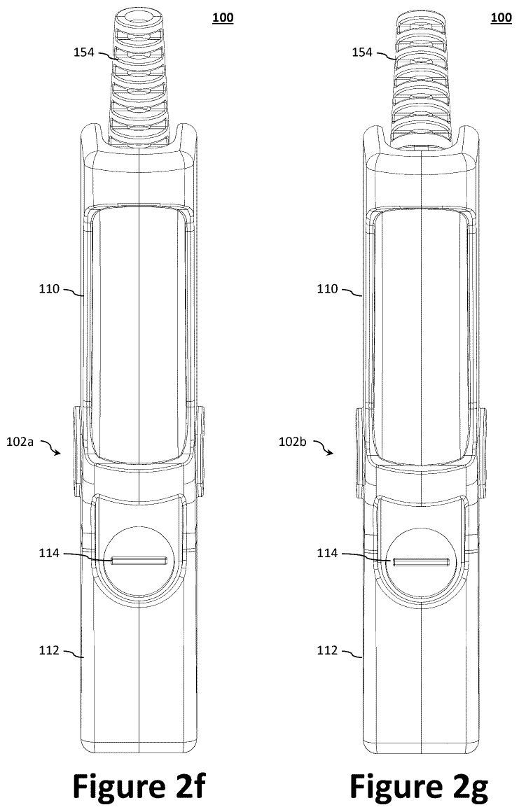

FIG. 2a illustrates a front perspective assembled view of the battery clamp assembly 100. FIGS. 2b and 2c illustrate, respectively, front and rear views of the battery clamp assembly 100, while FIGS. 2d and 2e illustrate, respectively, first and second side views of the battery clamp assembly 100. FIGS. 2f and 2g illustrate, respectively, top and bottom plan views of the battery clamp assembly 100.

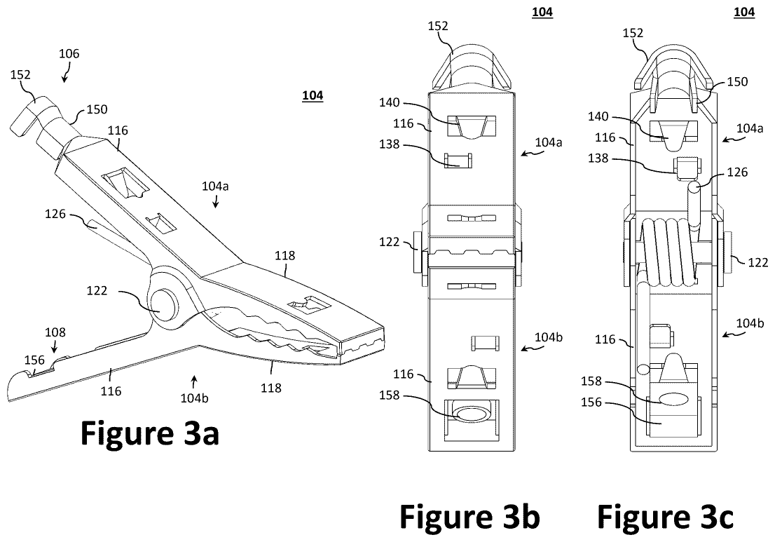

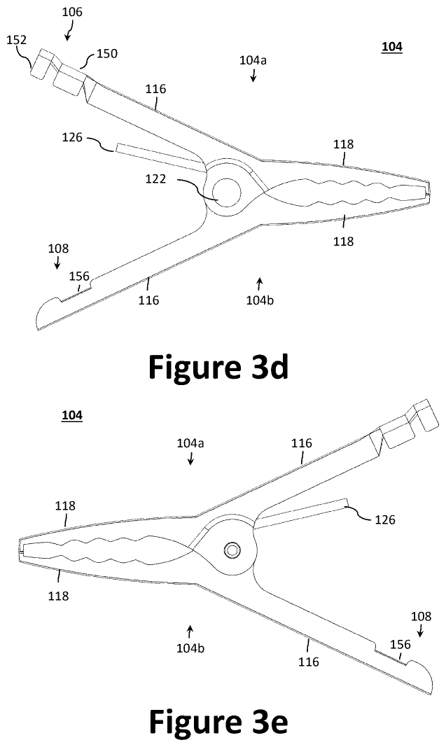

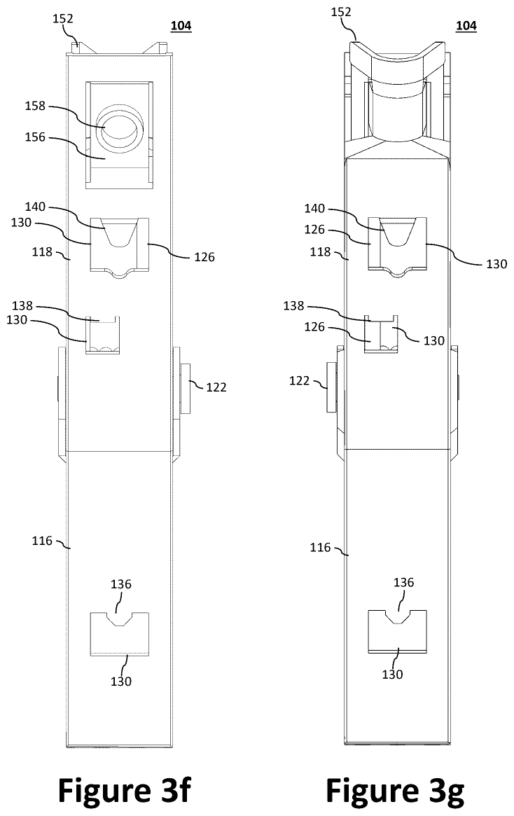

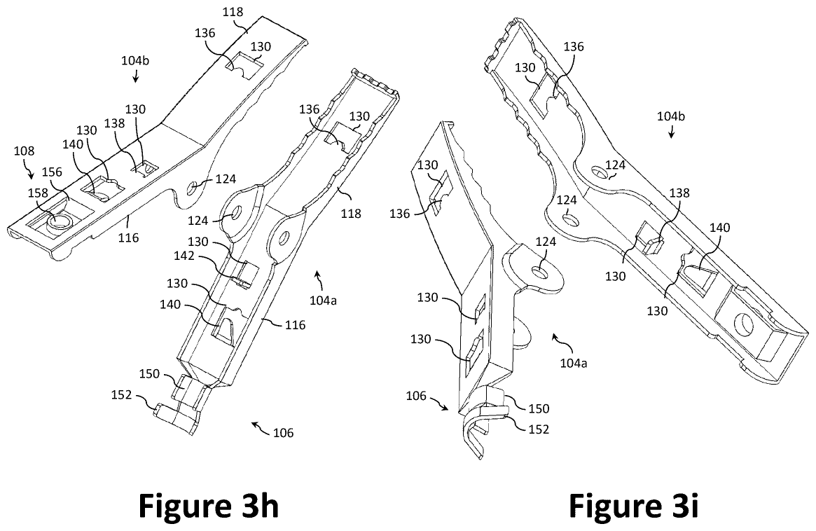

FIG. 3a illustrates a front perspective assembled view of the clamp 104. FIGS. 3b and 3c illustrate, respectively, front and rear views of the clamp 104. FIGS. 3d and 3e illustrate, respectively, first and second side views of the clamp 104. FIGS. 3f and 3g illustrate, respectively, top and bottom plan views of the clamp 104. FIGS. 3h and 3i illustrate, respectively, topside and underside isometric assembly views of the clamp 104.

The illustrated battery clamp assembly 100 includes two electrical connectors. More specifically, the illustrated battery clamp assembly 100 includes both a crimp electrical connector 106 and a threaded electrical connector 108. A battery clamp assembly 100 having a combination of both a crimp electrical connector 106 and a threaded electrical connector 108 (or other second electrical connector) allows for the same battery clamp assembly 100 to be used across applications with varying electrical requirements. Higher-current demands can be met using the crimp electrical connector 106, while the threaded electrical connector 108 offers convenience for less demanding connections.

Generally speaking, crimp electrical connectors 106 are able to carry higher currents than threaded electrical connectors 108. For example, different chargers and boosters may have different output ratings-certain of which may warrant crimp electrical connectors 106, while others may allow for threaded electrical connectors 108. Yet, there is still a desire to reduce the number of components during the assembly of a charger or battery booster. Therefore, providing a clamp 104 that comprises both a crimp electrical connector 106 and a threaded electrical connector 108 allows for the same clamp 104 (or battery clamp assembly 100) to be used in applications where higher currents are expected (e.g., using the crimp electrical connector 106) and where lower currents are expected (e.g., using the threaded electrical connector 108). An advantage of the disclosed battery clamp assembly 100 is that it reduces the number of components and assembly complexity, enhancing manufacturing efficiency and user versatility.

The illustrated clamp housing 102 comprises a first insulator 102a and a second insulator 102b. The clamp housing 102 can be made, for example, of an electrically insulating material (e.g., resin, synthetic resin, plastic, rubber, fiberglass, composite, or other suitable electrical insulating material). In one example, the clamp housing 102 can be made of plastic injection-molded material. Each of the first and second insulators 102a, 102b includes a handle insulator portion 110 and a jaw insulator portion 112. Jaw insulator portions 112 are equipped with polarity indicators 114, such as raised positive (+) or negative (−) polarity symbols, to denote the intended polarity of the battery clamp assembly 100. While illustrated as being on the jaw insulator portion 112, the indicators 114 could alternatively or additionally be provided on the handle insulator portion 110.

The clamp 104 comprises a first conductive clamp member 104a and a second conductive clamp member 104b. The components of clamp 104 can be made from stamped or forged electrically-conductive material (e.g., metal, steel, metal alloy, steel alloy, plated steel, chrome-plated steel, nickel-plated steel, aluminum, anodized aluminum, copper, or other suitable electrically conductive material). Each of the first conductive clamp member 104a and the second conductive clamp member 104b comprises a handle portion 116 and a jaw portion 118. In some examples, as illustrated, the jaw portion 118 comprises a plurality of teeth 120 to grip the battery terminals. The first conductive clamp member 104a and the second conductive clamp member 104b are pivotally connected via a pivot pin 122 or similar pivot component.

To that end, each of the first conductive clamp member 104a and the second conductive clamp member 104b comprises a set of pivot holes 124 configured to align and receive the pivot pin 122. As illustrated, the set of pivot holes 124 is positioned at the junction/interface between the handle portion 116 and the jaw portion 118. In other words, the proximal ends of the handle portion 116 and the jaw portion 118 are connected to one another at or adjacent to set of pivot holes 124

A spring 126, installed within the clamp 104, biases the first conductive clamp member 104a and the second conductive clamp member 104b together. The spring 126 includes a through-hole 128 to accommodate the pivot pin 122.

Each conductive clamp member 104a, 104b is provided with one or more slots 130 for connection with corresponding hook-shaped protrusions 132 on the insulators. The one or more slots 130 may include engagement features, such as the trapezoidal protrusion 136, perpendicular tab 138, and the ramped tab 140. In some examples, the hook-shaped protrusions 132 comprise a hook 134 configured to pass through and slide into the one or more slots 130 and/or to engage the engagement features thereof (e.g., the trapezoidal protrusion 136, perpendicular tab 138, and the ramped tab 140). As illustrated in FIG. 1c and 1e, the ramped tab 140 can be positioned relative to the hook 134 (e.g., behind the flat side of the hook 134) such that the ramped tab 140 can be bent to secure the hook 134 in the slot 130. As further illustrated, the slots 130 and protrusions 132 can be located on both the handle portions and clamp portions (e.g., each of the handle insulator portion 110, jaw insulator portion 112, handle portion 116, and jaw portion 118) to enhance structural integrity. Additional mechanical connections can be implemented for added stability.

The battery cable 144 comprises an electrical conductor 146 (e.g., cable, braided cable, wire, twisted wires) having an insulating sleeve 148. The clamp 104 is configured to connect with the battery cable 144 via both a crimp electrical connector 106 and a threaded electrical connector 108. That is, the user can use the same clamp 104 in applications that warrant a crimp connection and those that permit use of threaded connections.

The crimp electrical connector 106 is integrated into the first conductive clamp member 104a. As illustrated, the crimp electrical connector 106 is integrally formed with the handle portion 116 and configured to electrically couple with a conductor 146.

The crimp electrical connector 106 is configured to securely attach to the battery cable 144 by compressing a wire crimp portion 150 around the conductor 146 using a crimping tool and, in some cases, an insulation crimp portion 152 around the insulation of the battery cable 144. Crimp electrical connector 106 may include insulation or heat-shrink sleeves for enhanced durability and protection. This connection method ensures high-current capacity, making it suitable for demanding electrical applications. A cable strain relief component 154, or other type of cable gland, can be installed at the connection between the battery cable 144 and clamp 104.

The threaded electrical connector 108 is integrated into or coupled to the second conductive clamp member 104b. The illustrated threaded electrical connector 108 comprises a metal plate 156 oriented parallel to the handle portion 116 that includes a threaded hole 158 for accommodating a threaded fastener 160, such as a bolt. The threaded electrical connector 108 can be a separate component affixed to the second conductive clamp member 104b by welding, brazing, soldering, or mechanical fastening. In another example, the threaded electrical connector 108 can be formed as an internally threaded collar that is extruded and/or cold-formed from the second conductive clamp member 104b. That is, with reference to FIG. 1e, the illustrated metal plate 156 is shaped or extruded to define a collar that defines the threaded hole 158. In some examples, the battery cable 144 is therefore provided with a connector end 162 having a through-hole 164 for accommodating the threaded fastener 160 (e.g., often referred to as a ring terminal). The battery cable 144 is connected to the battery clamp assembly 100 by inserting the threaded fastener 160 into the through-hole 164 and then threading the threaded fastener 160 into the threaded hole 158 of the threaded electrical connector 108 until fully tightened, for example, using a screwdriver, socket wrench, or wrench.

The threaded fastener 160 is positioned near a distal end of the handle portion 116 (e.g., the end opposite the pivot pin 122) to facilitate access for tightening or loosening with minimal interference from the other handle portion 116. The fastener 160 connects to a battery cable 144 featuring a connector end 162 with a through-hole 164. Tightening the fastener 160 secures the cable 144, ensuring a stable electrical connection. The threaded fastener 160 is positioned at or adjacent an end of the handle portion 116 to allow improved access to the threaded fastener 160 for tightening and using a tool to fully tighten the threaded fastener 160 into the threaded hole 158 of the threaded electrical connector 108. Specifically, positioning the threaded fastener 160 at or adjacent an end of the handle portion 116 prevents mechanical interference with a user's finger attempting to tighten or loosen the threaded fastener 160, or with a tool attempting to tighten or loosen the threaded fastener 160.

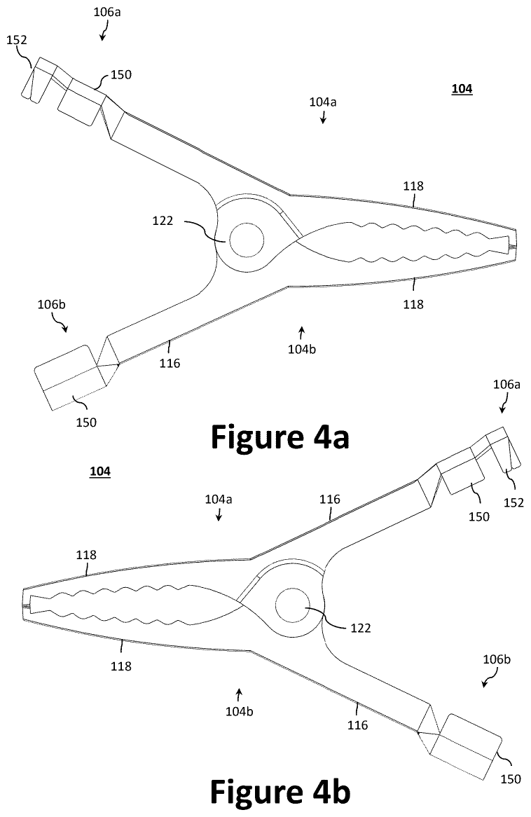

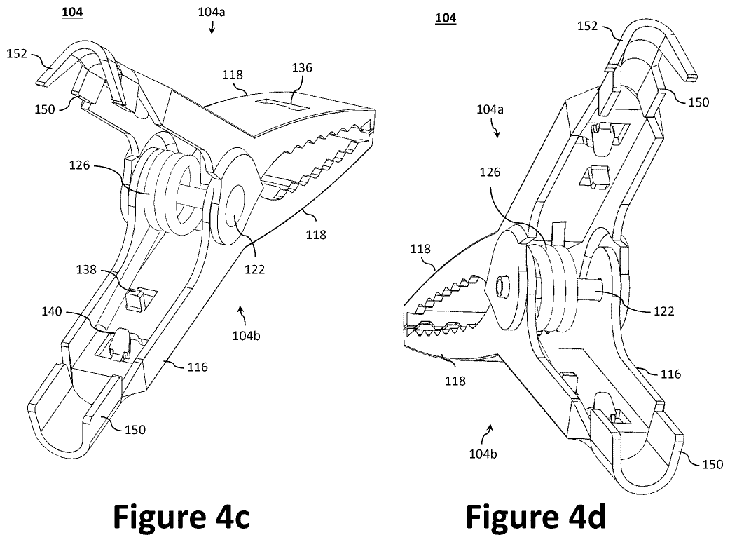

While the previously described battery clamp assembly 100 provides both a crimp electrical connector 106 and a threaded electrical connector 108, other configurations are contemplated. FIGS. 4a and 4b illustrate, respectively, first and second side views of a clamp 104 in accordance with another aspect having two crimp electrical connectors 106, while FIGS. 4c and 4d illustrate, respectively, first and second rear perspective views of the clamp 104. Specifically, in this example, the first electrical connector is a first crimp electrical connector 106a configured to couple with a first conductor and the second electrical connector is a second crimp electrical connector 106b configured to couple with a second conductor that is larger in diameter than the first conductor.

Further, in the illustrated example, the first crimp electrical connector 106a comprises both a wire crimp portion 150 and an insulation crimp portion 152, while the second crimp electrical connector 106b comprises only a single, larger wire crimp portion 150, but no insulation crimp portion 152. In this example, the diameter of the second conductor is sufficiently large to provide an adequate mechanical connection with the larger wire crimp portion 150, thus obviating the need for an insulation crimp portion 152.

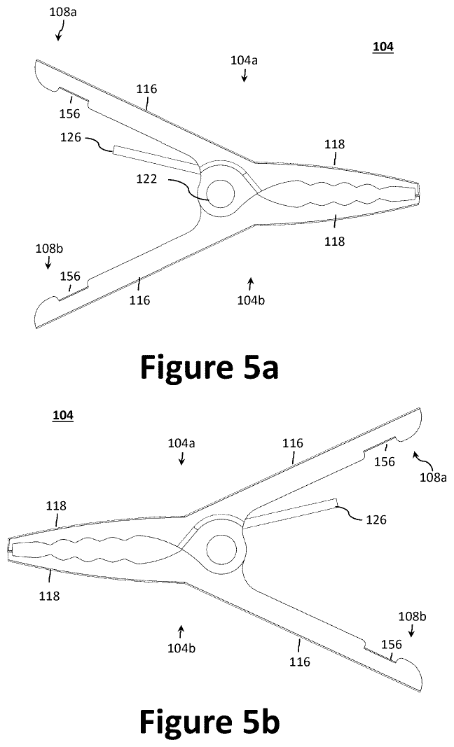

While the previously described battery clamp assembly 100 provides a clamp 104 with one or more crimp electrical connectors 106, other configurations are contemplated. FIGS. 5a and 5b illustrate, respectively, first and second side views of a clamp 104 in accordance with another aspect having two threaded electrical connectors 106. Specifically, in this example, the first electrical connector is a first threaded electrical connector 108a configured to couple with the connector end 162 of a first conductor via a first metal plate 156 and the second electrical connector is a second crimp threaded electrical connector 108b configured to couple with the connector end 162 of a second conductor 162 via a second metal plate 156 that is larger than the first conductor. To that end, the first and second metal plates 156 can be differently sized with differently sized threaded holes 158 to thereby accommodate differently sized threaded fasteners 160. For example, the size of the connector end 162 and associated threaded fastener 160 of a conductor rated for higher currents will typically be larger than that of the connector end 162 and associated threaded fastener 160 of a conductor rated for lower currents.

The above-cited patents and patent publications are hereby incorporated by reference in their entirety. Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the invention may therefore be practiced otherwise than as specifically described above.

What is claimed is:

1. A battery clamp assembly comprising:
a first clamp portion having a first handle portion and a first jaw portion,
wherein a crimp electrical connector is coupled to the first handle portion that is configured to electrically couple with a conductor;
a first insulator coupled to an exterior surface of the first clamp portion;
a second clamp portion having a second handle portion and a second jaw portion, wherein a threaded electrical connector is coupled to the second handle portion that is configured to electrically couple with a conductor, and wherein the second clamp portion is pivotally coupled with the first clamp portion via a pivot pin; and
a second insulator coupled to an exterior surface of the second clamp portion.

2. A battery clamp assembly comprising:
a first clamp portion having a first handle portion and a first jaw portion,
wherein a first crimp electrical connector is integrally formed with the first handle portion and configured to electrically couple with a conductor;
a first insulator coupled to an exterior surface of the first clamp portion;
a second clamp portion having a second handle portion and a second jaw portion,
wherein a second crimp electrical connector is integrally formed with the second handle portion and configured to electrically couple with a conductor, and
wherein the second clamp portion is pivotally coupled with the first clamp portion via a pivot pin; and
a second insulator coupled to an exterior surface of the second clamp portion.

3. A battery clamp assembly comprising:
a first clamp portion having a first handle portion and a first jaw portion, wherein a first electrical connector is coupled to the first handle portion; and
a second clamp portion having a second handle portion and a second jaw portion,
wherein a second electrical connector is coupled to the second handle portion, and
wherein the second clamp portion is pivotally coupled with the first clamp portion via a pivot pin.

4. The battery clamp assembly of claim 3, wherein the first electrical connector is a crimp electrical connector.

5. The battery clamp assembly of claim 4, wherein the second electrical connector is a crimp electrical connector.

6. The battery clamp assembly of claim 4, wherein the second electrical connector is a threaded electrical connector.

7. The battery clamp assembly of claim 3, wherein the first clamp portion is formed as a stamped metal component where the first handle portion and the first jaw portion are a unitary structure.

8. The battery clamp assembly of claim 7, wherein the second clamp portion is formed as a stamped metal component where the second handle portion and the second jaw portion are a unitary structure.

9. The battery clamp assembly of claim 8, wherein the second electrical connector is coupled to the second clamp portion via at least one of welding, brazing, soldering, and mechanical fastening.

10. The battery clamp assembly of claim 3, wherein the first clamp portion is formed as a stamped metal component where the first handle portion, the first jaw portion, and the first electrical connector are a unitary structure.

11. The battery clamp assembly of claim 10, wherein the second clamp portion is formed as a stamped metal component where the second handle portion, the second jaw portion, and the second electrical connector are a unitary structure.

12. The battery clamp assembly of claim 6, wherein the threaded electrical connector comprises a metal plate with a threaded hole configured to accommodate a threaded fastener.

13. The battery clamp assembly of claim 12, wherein the metal plate is oriented parallel to the handle portion and positioned at a distal end of the handle portion.

14. The battery clamp assembly of claim 12, wherein each of the first electrical connector and the second electrical connector is a threaded electrical connector.

15. The battery clamp assembly of claim 12, wherein the metal plate is coupled to the handle portion via at least one of welding, brazing, soldering, and mechanical fastening.

16. The battery clamp assembly of claim 3, wherein each of the first clamp portion and the second clamp portion comprises one or more slots.

17. The battery clamp assembly of claim 3, further comprising a first insulator coupled to the first clamp portion via one or more slots formed in the first clamp portion and a second insulator coupled to the second clamp portion via one or more slots formed in the second clamp portion.

18. The battery clamp assembly of claim 3, wherein the first electrical connector is a crimp electrical connector configured to couple with a first conductor and the second electrical connector is a crimp electrical connector configured to couple with a second conductor that is larger in diameter than the first conductor.

19. The battery clamp assembly of claim 3, wherein the first electrical connector is a first crimp electrical connector, and the second electrical connector is a second crimp electrical connector that is larger than the first crimp electrical connector.

20. The battery clamp assembly of claim 3, wherein the first electrical connector and the second electrical connector have different current ratings.
